(19) United States
(12) Patent Application Publication
(10) Pub. No.: US 2007/0169066 A1
(43) Pub. Date: Jul. 19, 2007

(54) System and method for an extensible 3D interface programming framework

(76) Inventor: Spencer Jesse Nielsen, Livermore, CA (US)

Correspondence Address: Spencer Jesse Nielsen, 1025 Lucille St., Livermore, CA, 94550, US

(21) Appl. No.: 11/600,619

(22) Filed: Nov. 15, 2006

Related U.S. Application Data
(60) Provisional application No. 60/738,142, filed on Nov. 17, 2005.

(51) Int. Cl. G06F 9/44

(52) U.S. Cl. 717/162

(57) ABSTRACT

A system for an extensible 3D interface programming framework is described. The system has a server portion for loading and processing software code and server modules having user interface software code and presentation software code. The server modules provide abstraction objects. A client portion for processing application specific software code capable of requesting one or more server modules to be loaded in the server portion for processing and requesting the server portion to instantiate objects and data from the server modules processing is shown. Software interface code interacts with the presentation software code. The server modules are loaded dynamically. One or more server modules may request one or more additional server modules to be loaded. The abstraction objects are attached to objects representing actual human interface devices. The client portion processes multiple applications having the application specific code. Multiple applications may make requests on one server module.

### CROSS-REFERENCE TO RELATED APPLICATIONS

The present Utility patent application claims priority benefit of the [U.S. provisional application for patent 60/738,142 on Nov. 17, 2005 under 35 U.S.C. 119(e). The contents of this related provisional application are incorporated herein by reference.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to the field of computer software technology. More specifically the invention is related to application frameworks and window servers.

### BACKGROUND OF THE INVENTION

Computer application interfaces have existed almost as long as computers have. Computer interfaces have moved from hardware switches to command lines to two-dimensional graphical interfaces. The next advance will be from two-dimensional interfaces to three-dimensional interfaces. Almost all computer interface systems have been developed and/or deployed by the makers of computer operating systems. They have relied on closed systems, which leverage the power of standardization and familiarity. This rigidity generally does not allow as much progression, creativity and flexibility in application interfaces as would an open and extensible system.

Over the past twenty years computer interfaces have deviated little from the paradigm established in the early 1980s of a keyboard and mouse providing human input with corresponding input abstractions such as cursors and data abstraction ideas such as windows, icons and menus. Advances such as leveraging the hardware compositing power of graphical processor units have come into play (Apple's Mac OS X) and most major operating systems seem to be heading this direction. However, there has been no indication of any intention of making another radical departure from the now standard 2D interface paradigm and closed working set of structures.

The idea of a 3D interface is not new; many companies and academics have been researching this topic for years. However, the computer world has not yet started to make the transition. Some reasons behind this delay are very simple. The technical and design barriers in implementing Such an interface are very large and there is always a (general attitude of hesitance or opposition to radical paradigm changes. Various implementations 3D interfaces and extensible programming, frameworks have been developed. But none yet are suited to deployment in an operating system. Many advancements in these fields have served in their limited narrow scope of application. Examples of such background art are listed below.

Some known approaches perform selection and manipulation acts using a multiple dimension haptic interface or Three-dimensional (3D) pointer. The framework of Such approaches is generally limited to one input abstraction paradigm. Other known approaches have a component system that is tied to specific frames, displays, or correspondence of hierarchy objects to visual onscreen objects. Generally, when procedures are responding, to events, they are defined by predetermined frameworks.

Representative conventional commercial research includes Microsoft's Avalon project and Sun's Looking Glass project. Both of which leverage 3D aspects but are still locked into the rigidity of a fixed set of interface constructs and do not allow (general access to graphics APIs. Academic research prior art are either also following the traditional interface paradigms and engineered to solve a specific task (SphereXP, Xgl, Tactile 3D, Win3D) or act as a general purpose programming, environment and do not concentrate on interfaces specifically (Croquet 3D).

The traditional interface paradigms have grown long in tooth and many have felt that they are overdue for replacement. Up and coming interfaces have not yet shown the potential for supplying complete frameworks suited to the next generation interface needs. For solutions that overcome the great barriers to implementing 3D extendable interfaces there is a great potential gain in the market of consumer operating systems.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary 3D framework integrated into an operating system, in accordance with an embodiment of the present invention;

FIGS. 2 and 3 illustrate an exemplary Rubik's cube implemented on different types of interface paradigms, in accordance with an embodiment of the present invention. FIG. 2 illustrates the use of a traditional interface paradigm, and FIG. 3 illustrates the use of a 3D interface paradigm;

FIG. 4 illustrates exemplary interface structure sources for an application that uses an extensible 3D interface programming, framework, in accordance with an embodiment of the present invention;

FIG. 5 illustrates an exemplary nonrestrictive human interface abstraction design, in accordance with an embodiment of the present invention;

FIG. 6 illustrates the input to visual response latency of an exemplary extensible 3D interface programming framework vs. that of a traditional paradigm, in accordance with an embodiment of the present invention;

FIG. 7 illustrates the graphics pipeline usage comparison between traditional paradigms and an exemplary extensible 3D interface programming framework, in accordance with an embodiment of the present invention;

FIG. 8 shows the segregation of code type in an exemplary extensible 3D interface programming framework, in accordance with an embodiment of the present invention;

FIG. 9 illustrates examples of code splitting proportions of programs, in accordance with an embodiment of the present invention;

FIG. 10 illustrates an exemplary implementation where the extensible 3D interface programming framework can be run as a window server/client program style system, in accordance with an embodiment of the present invention.

FIG. 11 shows an exemplary implementation where the extensible 3D interface programming framework can be run as a traditional API library, in accordance with an embodiment of the present invention;

FIG. 12 lists some differences between the paradigm described in FIG. 10 and the paradigm described in FIG. 11;

FIG. 13 illustrates the interdependence of modules in an exemplary extensible 3D interface programming framework, in accordance with an embodiment of the present invention;

FIG. 14 illustrates an exemplary distributed object messaging process, in accordance with an embodiment of the present invention;

FIG. 15 lists exemplary construct tree organizational pointers, in accordance with an embodiment of the present invention;

FIGS. 16 and 17 illustrate two different representations of the same construct tree, in accordance with an embodiment of the present invention. FIG. 16 visualizes it in terms of the actual organizational pointers, and FIG. 17 visualizes the object parent/child relationships;

FIG. 18 illustrates three exemplary ways of organizing both of these pieces of functionality, in accordance with an embodiment of the present invention;

FIG. 19 is an exemplary behavior attachment diagram in accordance with an embodiment of the present invention;

FIG. 20 illustrates how an exemplary Hinterface object interacts with an exemplary Abstraction object to process input and deliver it to an exemplary EventReceptor object, in accordance with an embodiment of the present invention;

FIG. 21 outlines possible parameters passed for the creation of EventReceptors, according to an embodiment of the present invention;

FIG. 22 illustrates two exemplary PanelLabel and one exemplary RoundedPanel Construct objects, in accordance with an embodiment of the present invention;

FIG. 23 outlines exemplary Timer object instantiation parameters, in accordance with an embodiment of the present invention;

FIG. 24 illustrates an exemplary Construct object being affected by a Timer object, in accordance with an embodiment of the present invention;

FIG. 25 lists exemplary major Environment methods, in accordance with an embodiment of the present invention;

FIG. 26 illustrates a client-server network architecture 100 that, when appropriately configured or designed, can serve as a computer network in which the invention may be embodied.

FIG. 27 shows a representative hardware environment that may be associated with the server computers and/or client computers of FIG. 26, in accordance with one embodiment.

Unless otherwise indicated illustrations in the figures are not necessarily drawn to scale.

### SUMMARY OF THE INVENTION

To achieve the forgoing and other objects and in accordance with the purpose of the invention, a system and method for an extensible 3D interface programming framework is described.

In one embodiment, a system for an extensible 3D interface programming framework is described. The system has a server portion for loading and processing code and server modules having user interface code and presentation code. The server modules provide abstraction objects as well as other kinds of interface objects. A client portion for processing application specific code capable of requesting one or more server modules to be loaded in the server portion for processing, and requesting the server portion to instantiate objects and data from the server modules processing is described.

In further embodiments the interface code interacts with the presentation code. The server modules are loaded dynamically. One or more server modules may request one or more additional server modules to be loaded. The abstraction objects are attached to Hinterface objects representing actual human interface devices. The client portion processes multiple applications having the application specific code. Multiple applications make requests on one server module. The applications process in protective sandboxes. The system has a GPU and the presentation code comprises graphics commands. The objects are organized by classes. Timer objects may be instantiated in the server portion. The system serves as a graphical user interface (GUI) of a consumer operating system.

In another embodiment, a method of programming, for an extensible 3D interface programming framework is described. The method having the steps of spitting an application code into a server module portion and a client process portion, creating abstraction objects associated with devices for the server module portion, providing presentation code for the server module portion, creating EventReceptor objects associated with the abstraction objects, providing programming code for exchanging data between the server module portion and the client server portion using the abstraction objects and the EventReceptor objects, providing code for loading the server module portion into a server processing means, and providing code for loading the client process portion into a client processing means.

In further embodiments, the code for loading the server module portion is dynamic. The method includes the step of providing code for loading external server modules into the server processing means. The method includes the step of organizing objects by classes. The method includes the step of providing a protective sandbox for the client process portion. The presentation code has graphics commands for a GPU.

In another embodiment, a system for an extensible 3D interface programming framework is described. The system has a means for split process programming and a means for programming platform for 3D interfaces. In a further embodiment. The system includes a means for providing a protective sandbox.

A computer program product is also provided, which implements some or all of the above functions.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. That is, it is to be understood that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

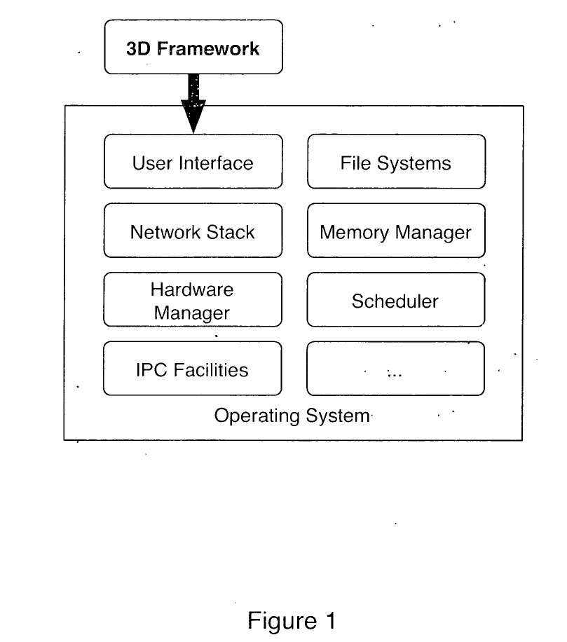

An aspect of the present invention is to provide application programmers with a flexible, robust and forward-looking programming framework with which to implement and execute graphical user interfaces. It is well known that although current operating systems have performed adequately in this area for the last twenty years, a system more suited to the computing requirements and hardware of the near future will be needed. Embodiments of the present invention are contemplated to fill that need in many, if not all such applications. Although, the present invention is not necessarily a complete operating system, per se, an aspect of the invention is to address at least the portion of the operating system that dictates what is seen on the screen, how people interact with programs on the computer and how the interfaces to those programs are built (see FIG. 1). Another aspect of the present invention is that the preferred embodiment has the ability to become a graphical user interface (GUI) of a consumer operating system. Another aspect of the present invention is that some embodiments may be configured to also function as a standalone application framework that runs alongside or within existing user interfaces of established operating systems.

Unlike known 3D frameworks that focus on specific definitions of interactive 3D objects, an aspect of the present invention is that it allows it to be definable through extendable middleware procedures when responding to events and is not tied to specific frames, displays or correspondence of hierarchy objects to visual onscreen objects. The event management and processing between the server and client are not unified in a queue or stack and separated out. Another aspect of the invention is that it maintains no synchronization of state between the server and the client. Some applications of the present invention are directed towards frameworks and tools that would be suited to creating interfaces and abstractions. However, it should be appreciated that the present invention is not specifically tied down to any one paradigm. Rather, it is an aspect of the invention that the framework of tools and code would allow easy development and creation of 3D applications. A feature of the framework is that it is made to be general and flexible enough to handle any sort of input abstraction that a programmer can think up. At least some of the embodiments of the present invention described below are suitable to be used as a framework of tools, programs, input methods, structures and abstractions that would be suitable to create such 3D interfaces to operating systems and applications.

Competition in the world of computer operating systems has started to heat up again in recent years. Usability and functionality are key issues in this arena. However, it is likely that the status quo will remain unless a player in that arena grabs hold of the next big thing, such as a new interface paradigm and provides an excellent implementation of it before their competition. The operating system market alone is worth billions of dollars per year to commercial operating system vendors, not to mention all the peripheral markets that are requisite or dependent on them. A great deal of market share can be captured if computer users are given an alternative that has the correct combination of style, power and usability. Because of the strengths of the present invention, the kinds of tasks that will shine when run on it are those in which massive amounts of complex data are visualized and interacted with in realtime. These kinds of interfaces cannot be built easily with systems based on the traditional user interfaces. This ability to interact with complex data sets in an intuitive manner and still support familiar interface paradigms will be a more persuasive argument for users to choose a particular operating system than has been offered in recent years. This “must have” feature will dictate the dominant party of the next phase of the operating system marketplace. It will then be that party who will ultimately receive the lion's share of the personal computer operating system market.

FIG. 1 shows where the extensible 3D interface programming framework fits into an operating system, in accordance with an embodiment of the present invention. In the present embodiment, the 3D framework is not an operating system itself. It is a component of the operating system, which dictates what is seen on the screen, how people interact with the programs on the computer and how the interfaces to those programs are built.

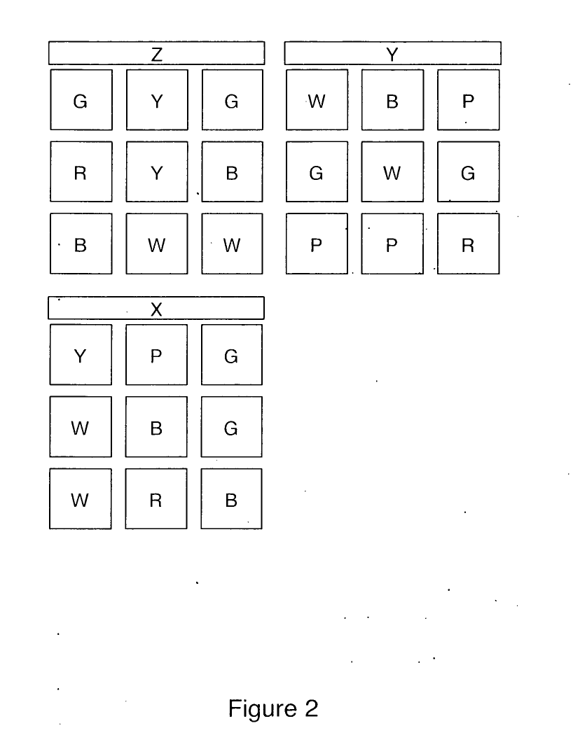

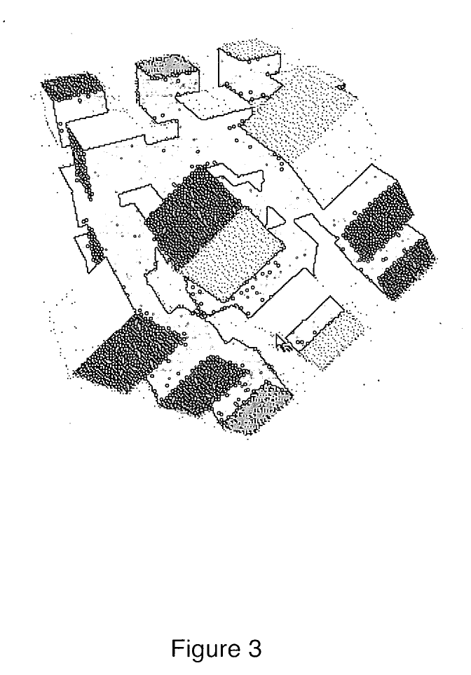

FIGS. 2 and 3 illustrate an exemplary Rubik's cube implemented on different types of interface paradigms, in accordance with an embodiment of the present invention. FIG. 2 illustrates the use of a traditional interface paradigm, and FIG. 3 illustrates the use of a 3D interface paradigm. Although application developers have been able to create 3D applications for many years, there is a great scarcity of application frameworks dedicated to operating in three dimensions. This means that, for the most part, programmers have had to create most of their 3D application interfaces from scratch, and only within the last ten years have they been able to use 3D rasterization APIs such as, but not limited to, OpenGL. The computing world at large is focused around 2D interface paradigms, and the shift into 3D has been very gradual because it requires a complete redesign of the way applications are designed, built and how they are used. Because the present embodiment is not restricted by two dimensions or display resolution based ideas, it has the correct base with which to provide developers a rich set of 3D interface programming tools. Although the concepts of depth, scaling and blending (translucency) have now been introduced into modern window servers, the programs that actually display graphics on behalf of other programs, the fundamental architecture to support 3D interaction does generally not exist in them. Ideas such as 3D projection, resolution/viewport independent presentation and shared hardware accelerated 3D contexts cannot be reasonably shoehorned into the existing, 2D paradigms. The present embodiment provides a fresh start with 3D interaction.

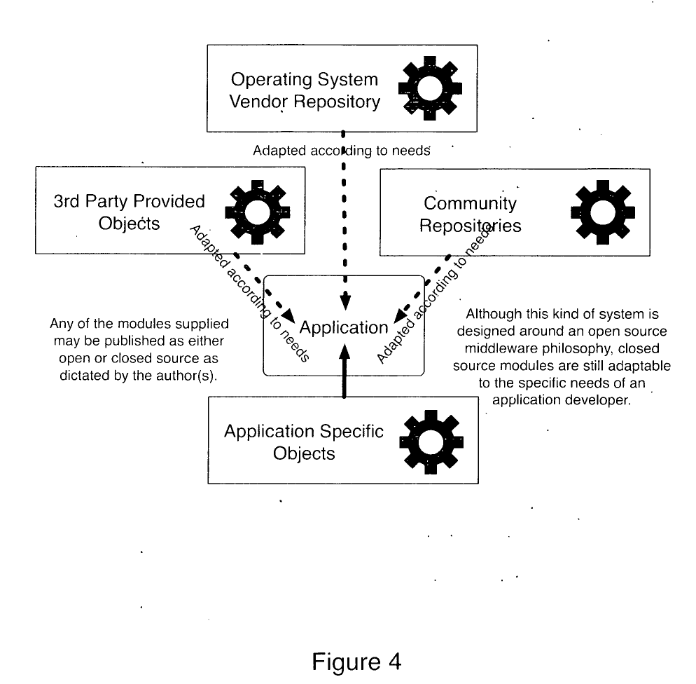

FIG. 4 illustrates exemplary interface structure sources for an application that uses an extensible 3D interface programming framework, in accordance with an embodiment of the present invention. For many years the keys to commercial application interfaces have resided strictly with the operating system vendors. Other than some level of appearance customization, programmers have had to learn to work within the confines of what they are given. They are not given access to source code or other resources that might better help them understand what their tools are capable of or even how to use them. The present embodiment of the present invention has been designed purely as an “engine” with no specific interface design elements such as, but not limited to, windows, buttons, menus, etc built into it. Instead of a program (shown as “Application” in the Figure) depending, on interface appearance and behavior defined in the framework it takes advantage of those procedures contained in middleware modules from sources outside the framework. Possible sources are described in the Figure. An application programmer may define interface appearance and behavior from scratch themselves (shown as “Application Specific Objects” in the Figure). They may also take advantage of potential modules provided by operating system vendor (shown as “Operating System Vendor Repository” in the Figure) as a standard base set in the window server/client program embodiment if it is commercially deployed in an operating system. An application programmer may also take advantage of middleware modules provided by other companies that choose to provide them (shown as “3^{rd} Party Provided Objects”). In addition an application programmer may leverage middleware modules provided by the development or other communities (shown as “Community Repositories”). All of the interface objects and interface code can be customized by the programmers at runtime. This means that programmers are not restricted to using any one set of interface designs and objects. They can use any set that they have available to them and even use them in conjunction with each other. A programmer or designer can even produce their own custom interface objects and choose to keep them for private use or make them available to others. It is contemplated that with use of the present invention no longer will programmers be restricted to designing, application interfaces to fit within the tools they are provided but they can now tailor the interface specifically to the application.

This kind of a system lends itself naturally to open source code repositories where maintainers publish a standard set of code and accept bug fixes and feature additions pending evaluation and testing. The present embodiment was designed with this kind of open source “middleware” system in mind because one of the best ways to learn how to use a system and understand how it works is to be able to see its source code. However, commercial middleware development can still exist and any portion of a middleware module can be either closed or open source. Even though middleware modules can potentially be closed source they can still be extended and customized by using programming language features such as but not limited to those present in Objective-C subclassing and message overriding.

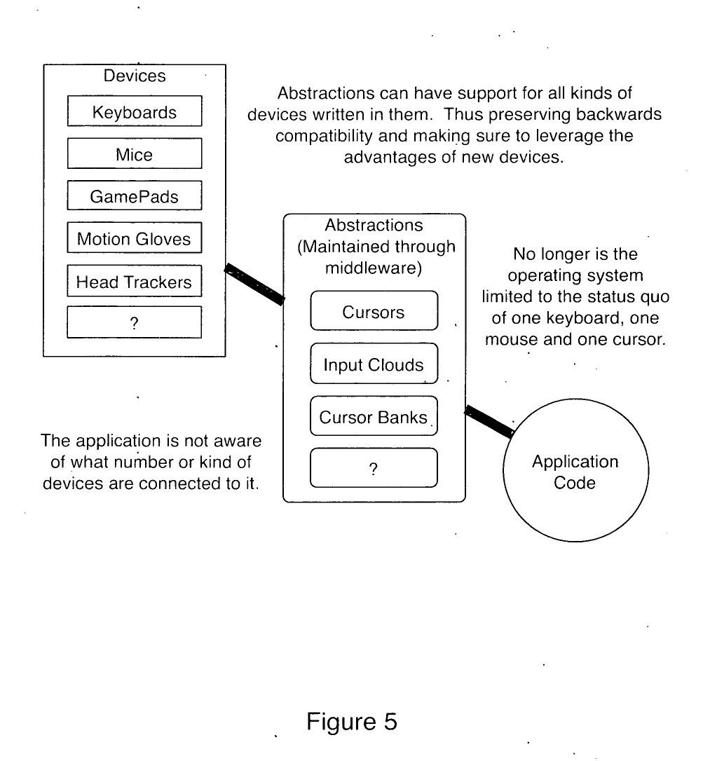

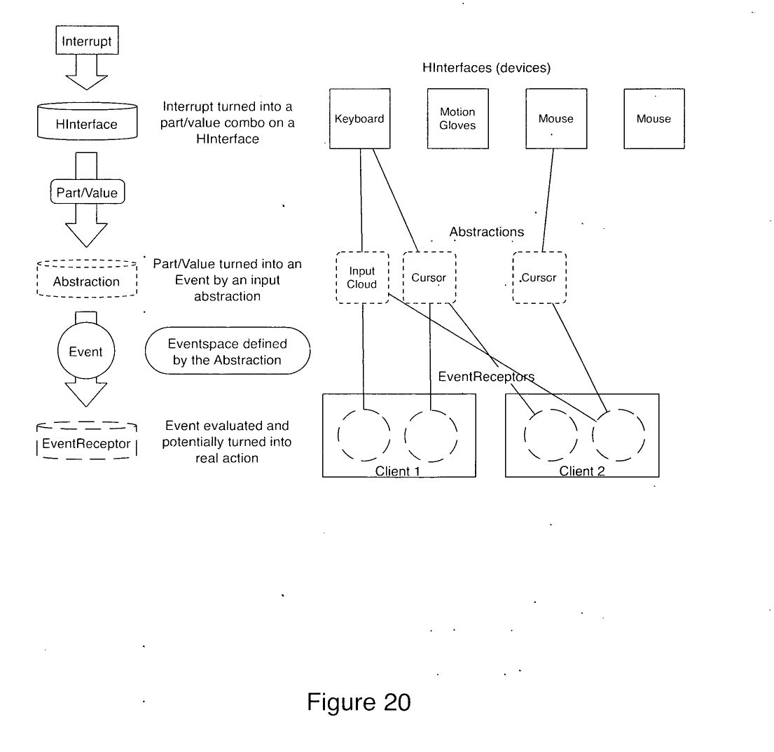

FIG. 5 illustrates an exemplary non-restrictive human interface abstraction design, in accordance with an embodiment of the present invention. Another place where modern interface systems are considered to be too restricted is in the realm of input device abstractions. The cursor has dominated the computing landscape for over two decades. Because the mouse cursor has been so integral to 2D dimensional interfaces, it has prevented new and potentially more efficient interfaces from attempting to break ground. New input devices such as, but not limited to, motion gloves and head trackers need abstractions that are more suited than the 2D cursor such as, but not limited to, input clouds (an interaction abstraction used for selection of objects with a dynamic three dimensional volume which shape is defined by human input) or multiple cursor groups. As will be described in more detail below (e.g., see FIG. 20), the present embodiment's input abstraction and event system is designed to be generalized and even input device agnostic. To handle inputs, application programmers often create objects that receive the input events, referred to herein for convenience as an EventReceptor, and associate them with Abstraction objects (as shown in the Figure). In the present embodiment, never do they interact in any way with the specific human interface device, which are represented herein by way of convenience as Hinterface objects. Because Abstraction objects can be associated with many different types of Hinterface objects and in turn many different types of human interface devices (as an example “Cursor” Abstraction objects are associated with both a Keyboard device and Mouse device shown in the Figure), the application using an Abstraction object has no indication of what kind of device is actually producing the input that the Abstraction object is translating and in turn feeding to its EventReceptor objects. In principle, neither the type of nor the number of interface abstractions is limited. Programmers can even create their own interface abstractions customized to their situations or input hardware. The present embodiment also allows for a very versatile backwards compatibility system so that state of the art input devices are fully taken advantage of but not required in a program. It should be noted that programs according to the present embodiment do not necessarily have to have an Abstraction, EventReceptor, or Hinterface objects.

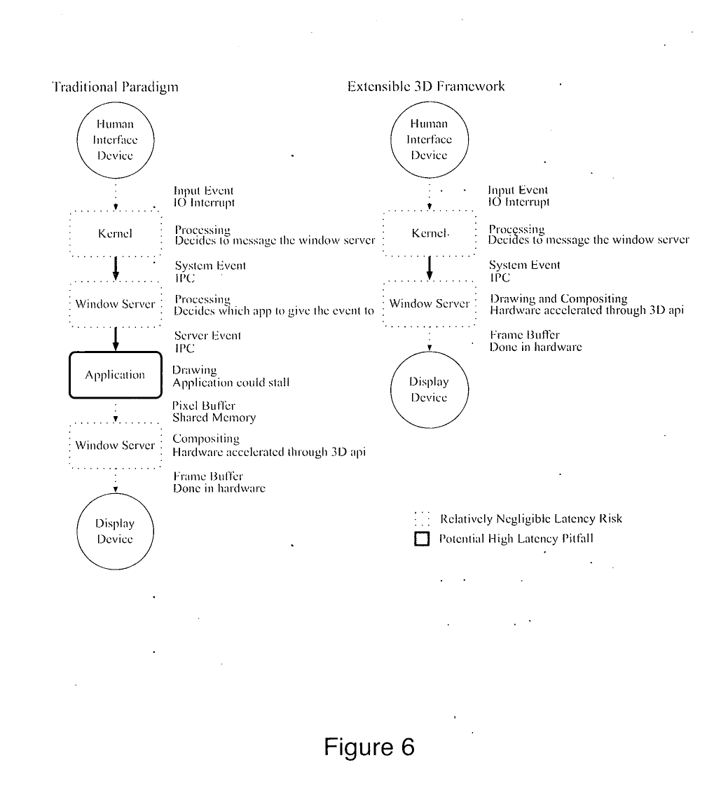

FIG. 6 illustrates the input to visual response latency of an exemplary extensible 3D interface programming framework vs. that of a traditional paradigm, in accordance with an embodiment of the present invention. One very important aspect in user interfaces is visual responsiveness. When the user provides input, it is useful to have some sort of visual, or sometimes audible, response that clearly conveys to the user that it acknowledges the input and that it is doing, or has already done, what has been requested of it. Although modern systems are very fast, visual response is still limited to the time that the window server can communicate with the client program, the time it takes for the program to create the visual response and then for the window server to composite the result. In the present embodiment, the visual response is not subject to as much of the communication latency and happens as soon as the event hits the window server and gets published.

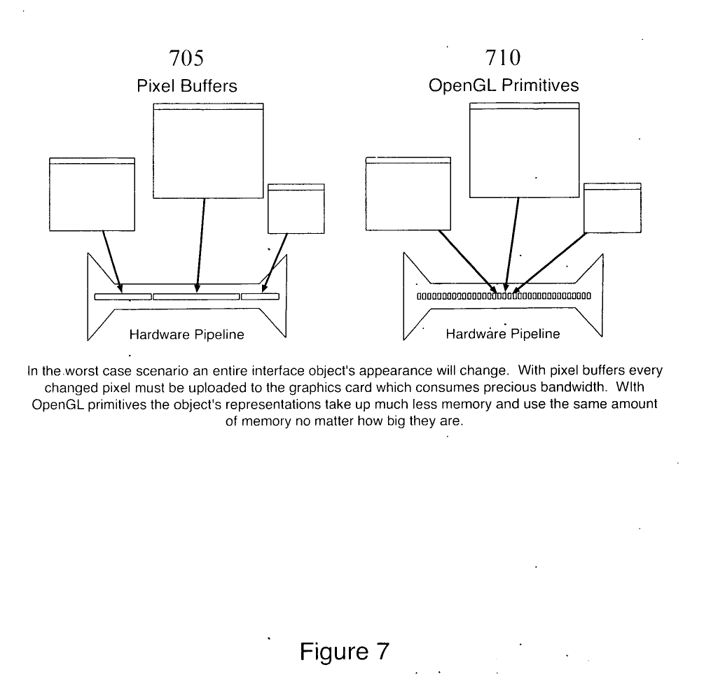

FIG. 7 illustrates the pipeline usage comparison between traditional paradigms and an exemplary extensible 3D interface programming framework, in accordance with an embodiment of the present invention. A traditional window server 705 is based on pixel buffers to manage content for display on behalf of the system. While it was the correct choice in the beg,inning of graphical interfaces, it now results in clogged graphical pipelines as window servers move towards compositing and effects run on the GPU (graphics processing unit). Every time a pixel buffer is changed it must be transferred through the graphics pipeline up to the graphics card.. This means that, if very large portions of a pixel buffer are being changed every frame, there will be a large upload, which will take up precious bandwidth every frame. An extensible 3D interface programmable framework 710, according to the preferred embodiment the present invention, is based on the graphics primitives of 3D rasterization APIs such as, but not limited to, OpenGL. Thus, instead of pixel buffer uploads, it sends small graphics commands through the pipeline which take up much less space and leverage the strong graphics capabilities of the GPU. This approach is generally both more efficient and much faster. Also, it is contemplated that the present embodiment will scale very well as display resolutions become higher and graphics cards become more powerful.

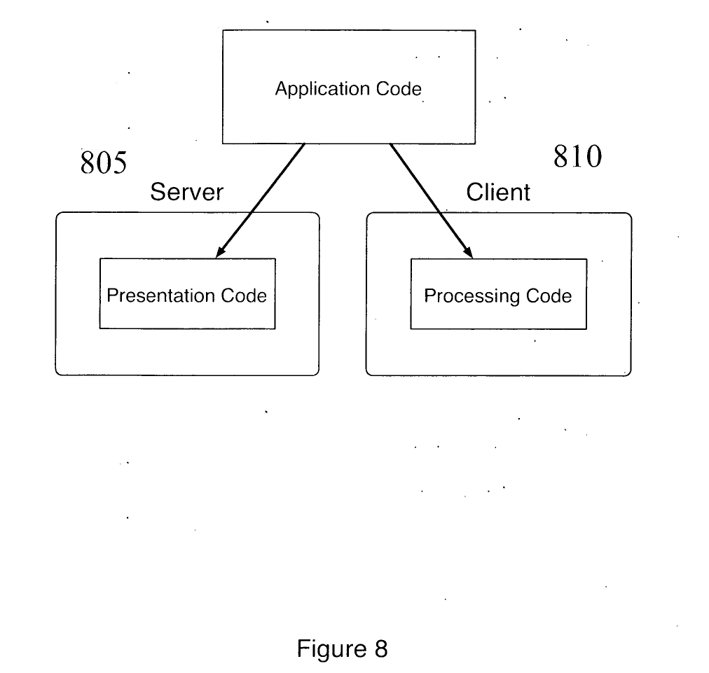

FIG. 8 shows the segregation of code type in an exemplary extensible 3D interface programming framework, in accordance with an embodiment of the present invention. The operation of the present embodiment is divided into two different kinds of actions: actions that occur on the server 805 and actions that occur on the client 810. The server holds all of the state for the GUI (graphical user interface) and has the responsibility of rendering it to the screen, communicating with the client side and loading resources on behalf of the client side. Clients communicate with the server about its needs and perform specified application functionality.

The foregoing design paradigm addresses at least two problems. A first problem is that of allowing multiple processes to all contribute to one graphics API context for collective rasterization, presentation and interaction. Because modern graphic API contexts such as, but not limited to, OpenGL or DirectX are local only to a single execution thread at a time that means that only one thread of one process can hold the responsibility of actually managing the visual content. Through means of IPC (interprocess communication), client programs wishing to use the window server to run graphics API commands can send messages with such requests. However, this requires too much overhead. Thus, the latency of current IPC methods introduce a second problem. Existing IPC latency is not low enough to support real-time human interfaces in the way that the present embodiment of the invention provides. The latency between the time that an event hits the window server to the time that the visual consequences of that event are observed is too great in some situations. Addressing these considerations, at least in part, motivates the preferred embodiment's departure from the traditional way of doing things.

An approach, in accordance with the preferred embodiment of the present invention, that addresses problems is to separate the portions of the program that deal with the user interface and presentation out from the main processing work of the program. All objects, data and code having, to do with the user interface are stored in dynamic library modules, which the window server loads into its virtual address space on behalf of client processes that wish to have that code executed. By itself, the window server contains no code having to do with specific user interface constructs. Thus a client process may request that the window server load any number of dynamic libraries (hereafter referred to as “server modules”) on its behalf as well as make requests that the window server instantiate objects and data from those server modules. Client processes can retrieve object pointers of those objects instantiated in the window server and treat them just as if they were objects that exist in the client's own virtual address space, with the exception of direct member variable access. The server modules that the client process requests can be those in repositories meant for general use, third-party libraries or completely custom server modules designed only for one client program alone. Although it is not the preferred embodiment for the present invention, presentation and processing code may be combined but it then limits other aspects that might prevent different kinds of implementations.

Under the present embodiment, application developers will write their programs in two portions. One portion is the workhorse, which needs extensive CPU cycles, specialized timing, specialized hardware support, a complete virtual address space or any other things that applications may require other than the user interface. The other portion is composed of server modules, which contain all the code that makes up the constructs that users are going to interact with in order to use the program. Preferably, these server modules would also leverage code in other server modules such as, but not limited to, those in a repository so that application development can be done more quickly. The design decisions behind what code goes into the server module and what code remains in the client process is very relevant to the program's stability, security, speed and ease of development. Preferably, any data created by the client process that has a direct and immediate impact on the visual interface should be passed up to the corresponding objects which are instantiated from code in the companion server module residing in the window server through language level messaging, for example, without limitation, as Objective-C messaging.

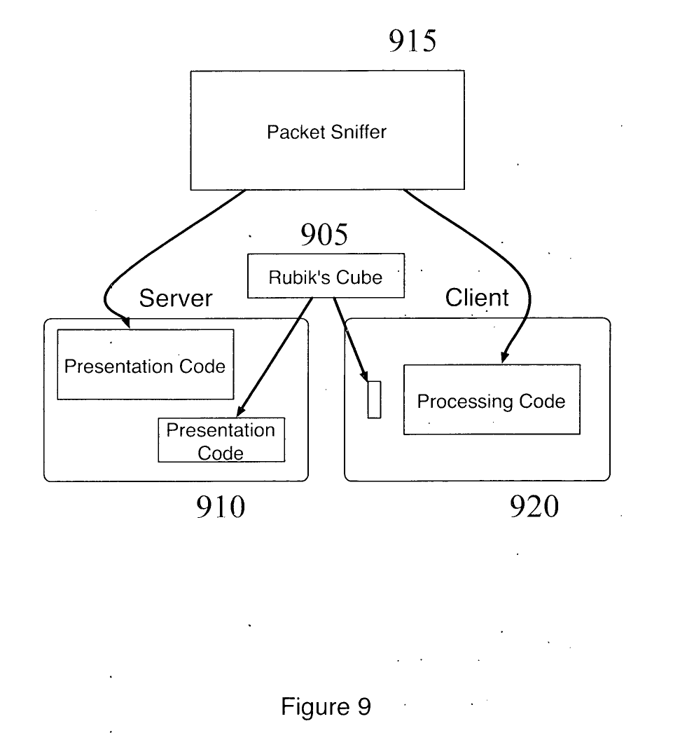

FIG. 9 illustrates examples of code splitting proportions of programs, in accordance with an embodiment of the present invention. Some programs may lend themselves to an entire existence in the window server without any need to communicate with the client process. Most of the time these are smaller, more graphically oriented pro(rams. One example of this kind of a program, without limitation; is a Rubik's cube 905. Because all code and data having to do with maintaining the state and interaction of Rubik's cube 905 directly and immediately impacts its presentation and interface it is appropriate and preferred that it remain entirely within a server module 9 10. An example of a fairly even code volume split includes, without limitation, a packet sniffer 915. All of the networking code and callbacks remain in a client process 920 and it sends messages to its counterpart objects in window server 9 10 indicating that new packets have arrived and that they need visualization. The objects on server 9 10 then react accordingly to these messages by creating other objects, changing values or other appropriate code.

In the present embodiment, this separation of code allows the client programs access to the graphics API context which addresses the first problem described above; sharing graphics API contexts. With regard to the latency problem, because there is very little, if not no, messaging overhead between input and interface code that could be susceptible to the operating system scheduler and system load, the latency becomes negligible. Once events hit the window server, the consequences are evaluated and executed almost immediately, thus making the latency substantially lower.

Although the present embodiment was designed to allow the server and the client portions to reside in separate processes, in some embodiments they can also be kept in the same (i.e., one) process or even on separate computers. In the case that the client and server portions are in the same process the two portions may communicate with each other without the overhead of expensive interprocess communication. In the case that the client and server process are on two different processes on two different computers communication between the two could be conducted through network or internet communication which would enable a person to interact with programs and system that are remote to their physical location. Two different implementations of the present invention are described by way of example, and not limitation, and contrasted below.

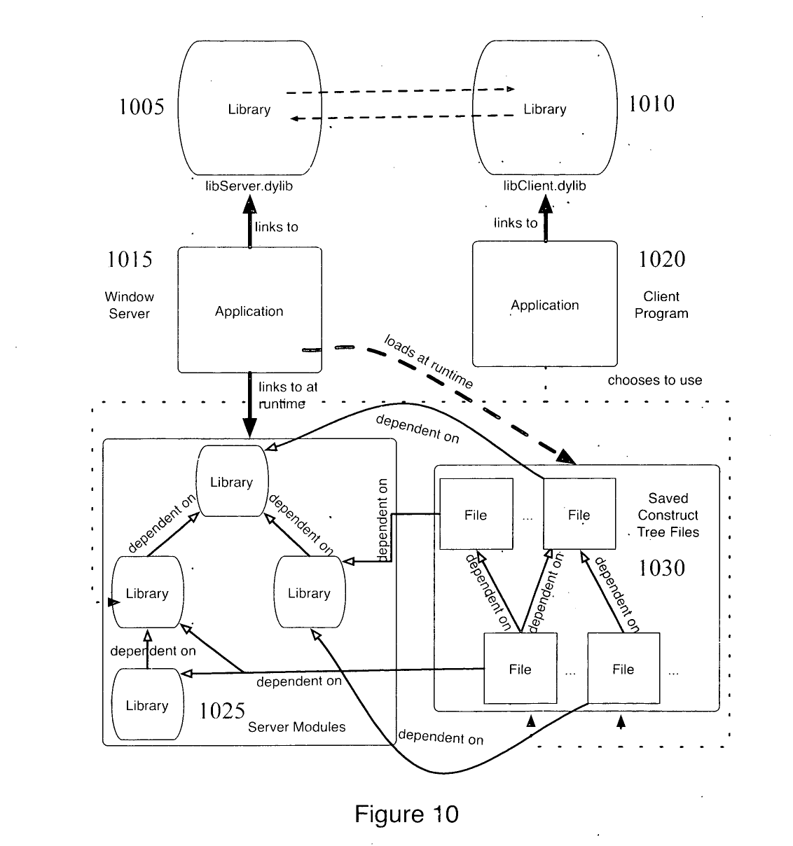

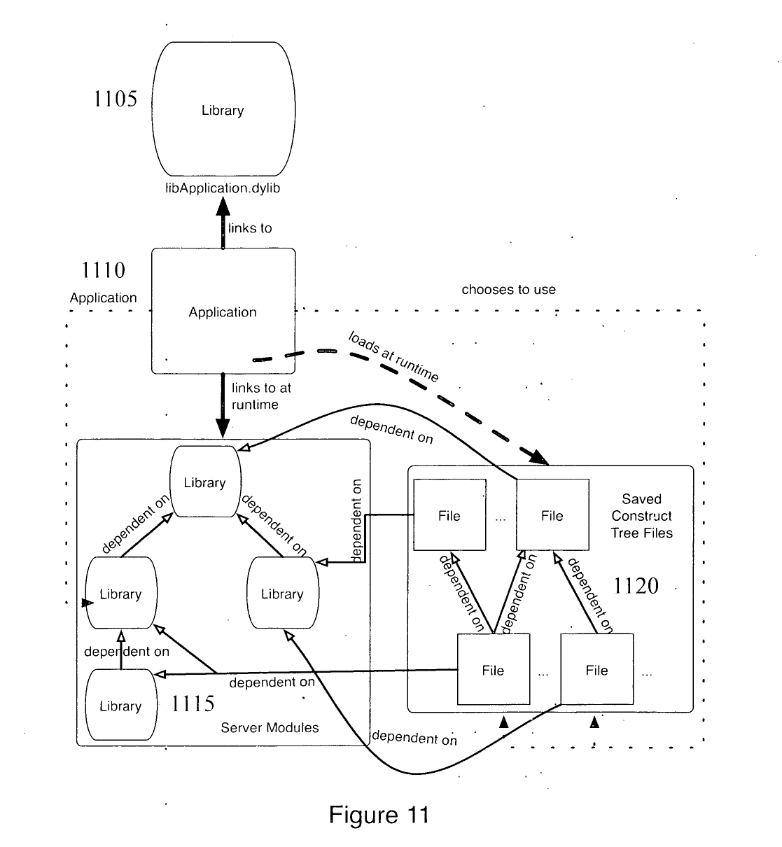

Those skilled in the art will readily recognize, in light of the teachings of the present invention, that there is a multiplicity of alternate and suitable ways to implement the present invention depending, upon the needs of the particular application. FIG. 10 illustrates an exemplary implementation where the extensible 3D interface programming framework can be run as a window server/client program style system, in accordance with an embodiment of the present invention. In this embodiment functionality is segregated and there is interprocess communication. FIG. 11 shows an exemplary implementation where the extensible 3D interface programming framework can be run as a traditional API library, in accordance with an embodiment of the present invention. In this embodiment, applications simply link to the API library and all client and server activity occur within the same process.

The window server/client program paradigm, shown in FIG. 10 and hereafter referred to as the “window server” paradigm, is preferably used when the invention is being run as a window server process. Depending upon the needs of the application, it may be run as, without limitation, the primary window server or one that runs alongside or within the primary window server. The application library paradigm, shown in FIG. 11, is used to create standalone programs that run within the primary window server. In the window server paradigm the server and client portions of an application reside in the window server 1015 and client program 1020 processes respectively. At compile time the window server 1015 and client program 1020 programs link to the server library 1005 and client library 1010 respectively. It is through code contained in these libraries that communication between the server and client portions of the program occur. At runtime as requested by the client program 1020 (or as it deems fit) the window server 1015 process will load in server modules 1025 in order to define appearance and behavior of interface constructs used by the client program 1020. Saved construct tree files 1030 contain saved states of interface constructs such as but not limited to control dialogs, interactive panels or any organization or arrangement or construct objects that the programmer deems too complicated to construct manually with code. In the application library paradigm both the client and server portions reside in the application 1110 process. The extensible 3D framework is linked to at compile time from a code library 1105. Like the previous paradigm the process that holds the server portion of the application (application 1110) may load in server modules 1115 or construct tree files 1120 for purposes of extending and supplying functionality and making interface construction easier.

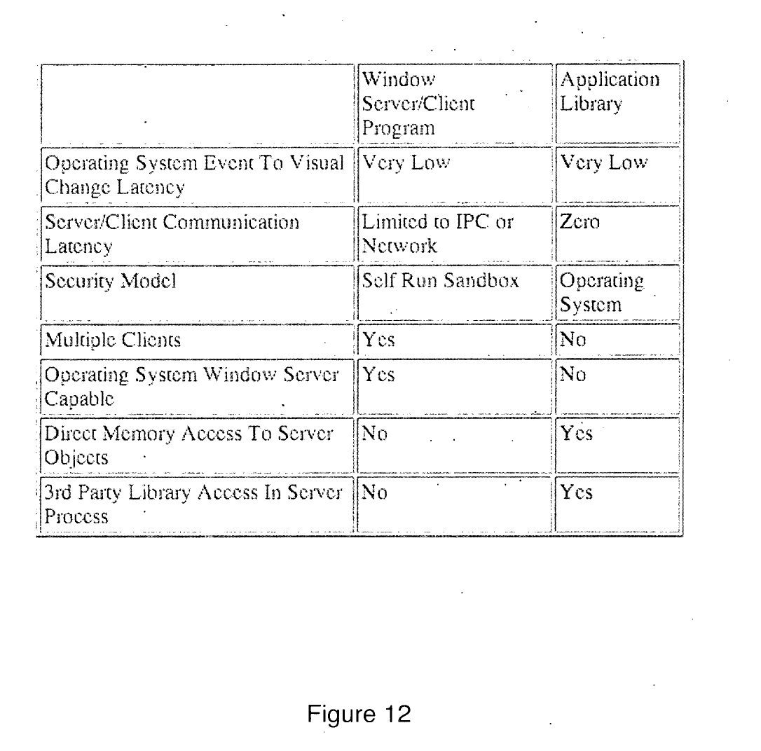

FIG. 12 lists some exemplary differences between the paradigm described in FIG. 10 and the paradigm described in FIG. 11. These two different embodiments of the invention are preferably implemented as similar as possible to facilitate easy portability of programs between both paradigms. There are differences of note, however. Server/client communication latency can be an issue in the window server if messages are passed from the client side to objects that reside in the server too often, whereas in the application library paradigm, there is generally no penalty from messaging at all (as addressed in the “Operating System Event To Visual Change Latency” and “Server/Client Communication Latency” rows in the Figure). Thus, the segregation of function into server modules and client code becomes a very relevant design decision. The security model of the window server is tighter than that of the application library (as shown in the “Security Model” row in the Figure). This means that low-level operations and things such as, but not limited to, Objective-C categories that are allowed in the application library are not allowed in the window server, described below. Because the window server paradigm can handle multiple clients at once it is a more favorable implementation when integrating such a system into an operating system (as shown in the “Multiple Clients” and “Operating System Window Server Capable” rows in the Figure). Because direct memory access to server objects is banned in the window server (as shown in the “Direct Memory Access To Server Objects” row in the Figure), all access from the client must happen through programming language level messaging. This requirement does not generally exist in the application library. An application library program may link to and take advantage of any third-party libraries but server modules, and thus in turn the window server may not perform such linking (as shown in the “3^{rd} Party Library Access In Server Process” row in the Figure). The client program in the window server paradigm however may link to third-party libraries. Because of these differences each system is more favorable depending on what the nature of the end deployment of the system is.

Because server modules are very relevant in the operating architecture in many embodiments of the present invention, their role is of concern, and care should be taken in their design. The application library paradigm generally does not require that any code be loaded in at runtime and all relevant design code may be linked to at compile time. However, there is great power in keeping generally used design code in separate outside server modules. Some helpful aspects of this include the leveraging of publicly distributed server modules, which would preferably be open source, robust and feature rich. These modules would most likely provide commonly requested functionality thus alleviating the programmer from having to re-invent the wheel. It also encourages programmers to follow modular code design, reuse existing code and write more general and flexible code.

A server module can reside anywhere suitable with a general consideration that the code requesting it be loaded into the server is aware of where it resides. Some embodiments of the present invention however, also include the ability to recognize a specific directory that is reserved for use as a repository of modules, which can be made available to all programs for use.

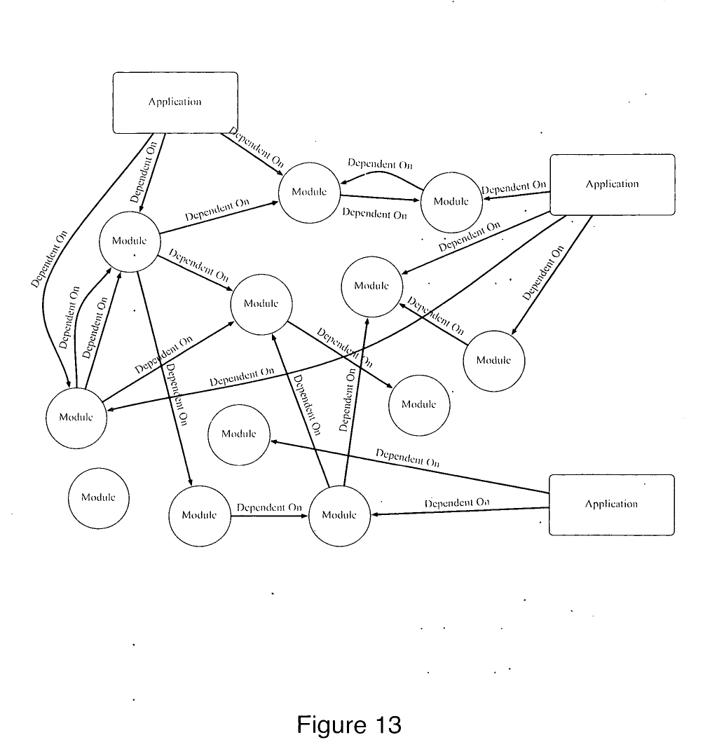

FIG. 13 illustrates an exemplary interdependence of modules in an extensible 3D interface programming framework, in accordance with an embodiment of the present invention. When modules are loaded from files into the memory space of the server their constructor and destructor routines ensure that the language runtime is properly prepared and that all necessary symbols are resolved before any code within the server module is executed. Because multiple modules may be dependent on the same server module, instead of loading it multiple times the server increments its reference count and keeps track of which clients are dependent on which server modules. When the clients disconnect from the server all the resources that were requested and allocated on its behalf are released. In the preferred embodiment, only when a server module's reference count is decremented to zero is the module actually removed from the process space and the language runtime altered accordingly. There could be however other methods for module removal such as quick reloading in which the module is unloaded and reloaded to take advantage of any changes that might have occurred during runtime. In this method inter-module reference counting would not be followed because the code will simply be upgraded to the latest version and there is no need to disturb the reference count.

When the server and client portions are present in the same process space in the application library paradigm communication generally does riot need any special support. However, in the window server paradigm communication is facilitated by language level distributed objects.

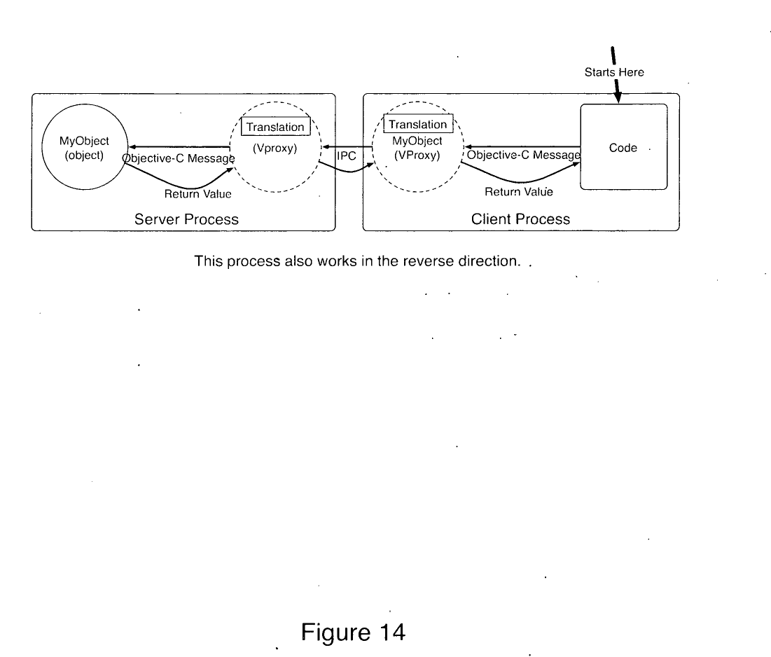

FIG. 14 illustrates an exemplary distributed object messaging process, in accordance with an embodiment of the present invention. Communication in the split process situation is handled by transparent programming language messaging. This means that even though the actual objects (e.g., “MyObject” in the Figure) that the client needs to message reside in the server process it can accomplish this by instead sending the message to a proxy (e.g., “Vproxy” in the Figure) and vice versa. As far as the client program is concerned though, the object that it is messaging is generally not a proxy but is for all messaging purposes the actual target object, and it is actually typed as such in the code. From the client program's perspective, it cannot tell what objects reside in its process space and which ones reside in the server's. When a program sends a message to an object that it thinks is of a specific type but is actually stored as a proxy, IPC occurs as described below.

In the present embodiment, if the receiving object is of the proxy type then the programming language runtime will fail to find the message and will forward it using the distributed objects functionality in the proxy object. A function such as, without limitation, methodSignatureForSelector( ) is called to obtain the call stack structure (signature) for the method. The function first searches explicitly assigned/cached signatures to see if it is there. Then it tries to see if the signature is within the current language runtime. If all else fails, the function asks the receiving process for the signature. A function such as, but not limited to, forwardInvocation( ) is then called to actually forward the call to the real object. This function runs through all the arguments, pushed proxies, selectors and data and performs address translation if necessary. The function then creates the argument frame. Then it creates the IPC message and sends it. It receives the return value (if any) and deals with data that has been pushed. On the receiving end a function such as, but not limited to, requestCallback( ) receives the IPC message and services it accordingly. If it is a method call then the function follows three major steps. First, it performs proxy and other translations as needed. Second, it actually sends the message. Finally, it packages up the return value and sends it back to the calling process.

When proxies or actual objects are passed as parameters in messages that undergo this process they are translated into values that correspond to their counterparts in the other process. Scalar parameter values however such as but not limited to ints, floats and arrays are simply copied over. If the corresponding counterpart does not exist then it is created on the fly. When the server and the client initially connect there is an object of a special type that is passed across which is then used by the client to send messages to the server and consequentially receive more remote objects which it can then send messages to. This system then grows as more messages are passed and more objects are passed and returned. Upon client disconnect all proxies and associated resources on both sides are released.

In the window server paradigm, there are inherent risks associated with loading unknown and potentially malicious code into a process. In doing so, much of the protection offered by the operating system, such as, but not limited to, individual virtual address spaces, memory protection, segregated execution flow and COW (copy on write) access to shared code, is lost. For at least these reasons an application's sensitive information should preferably never reside within the window server and information such as, but not limited to, passwords or other input that must pass through the window server should be obfuscated and purged as soon as possible. Despite the loss of many operating system protections in exchange for speed, extensibility and a shared graphics API context, many of these protections are still possible. Using existing operating system tools and features, protective sandboxes are built, preferably according to the teachings herein, for client processes' code to run in, which provide robust protection for both the server modules themselves and the window server from damage or intrusion, either unintentional or malicious. Such sandboxes place restrictions on the kinds of things that code in server modules can do but are still flexible enough to allow any kind of programming required for a user interface. The protective features are outlined below with respect to the kinds of attacks/damage against which they are meant to defend.

Memory leaks can be caused when sections of memory lose their reference(s) or are not deallocated correctly. This problem can be addressed through the use of modified malloc routines and malloc zones, or similar operating system feature for example, without limitation as long as the virtual memory manager or underlying memory support library supports features such as but not limited to memory regions or zones. The window server cordons off sections of its main thread's execution as being executed on behalf of specific client processes. Any memory allocation that occurs in that execution sub-section will be placed into a corresponding malloc zone. For allocations not ultimately done through malloc such as, but not limited to, vm_allocate in Darwin, see sections on rouge library/system calls. When a client process disconnects from the window server, all of its resources are deallocated by simply destroying its corresponding malloc zone. Any memory that had not been deallocated at cleanup will then be recovered. To help avoid both memory leaks and the allocation of excessive sizes during runtime the custom malloc routines monitor the zone sizes for the client processes and no longer allocate memory beyond specific limits without special permission from the server.

Sometimes server module code causes exceptions to be raised. The default behavior of most exceptions is to exit. Preferred embodiments of the present invention install a custom exception handler that, instead of exiting, analyzes where the exception was raised and then quarantines or removes the offending code, rebuilds the stack and processor state to a safe point of execution flow and continues on with the program execution.

Another problem that can arise is rampant memory access/corruption by a server module over the window server or other code modules. This can be caused by negligent or malicious code in the server module. The preferred window server embodiment addresses this problem in the following way. When the window server hands over execution to code in a server module it first locks every malloc zone in the window server except the corresponding zone for the server module by changing their virtual memory privileges to disallow read, write and execute. There is also a small portion of memory with execute access held as a restore island used, in the preferred embodiment, only to switch the locks around. The nature of the code in the switch islands is such that they cannot easily be subverted into doing anything other than passing control correctly and switching the locks correctly. If a memory access to a malloc zone that is locked down occurs, then an exception gets raised (see above Exceptions problem).

In some cases a server module intentionally or unintentionally may try to call a library function outside of the scope of allowable calls for server modules. To address this, some embodiments of the present invention apply the solution from the rampant memory access problem as well as a pre-load code scanner. In such embodiments, the window server employs a pre-load code scanner which will search for references of library functions or system calls outside the scope of itself, dependent server modules, authorized dependent libraries, authorized window server code and other authorized code and not allow importation of the server module if any are found. In the present embodiment direct system calls are preferably outlawed altogether, although obviously indirect access will be necessary and present. Because system calls are preferably not allowed this will, significantly reduce, if not, prevent easy construction of function branches, system calls or other behavior created through arithmetic. Custom branches might be possible to construct on the execution stack, but as long as the pages they branch to are either authorized or protected, there will be no breach.

In some cases the problem of stalling/non-exiting routines or slow routines may occur. This is caused when code in a server module gets caught in an infinite loop or takes an unreasonable amount of time to execute thus ruining the performance of the entire window server. To help avoid this problem, the present embodiment preferably includes an optional maintenance process that periodically wakes up and checks the status of the window server thread. If a certain amount of time has gone by but no more frames have, then the server determines that somewhere in user code there is a slow or stalled routine. It checks to see what code the primary thread is running in and decides to either remove it, quarantine it, reset it or whatever the situation requires.

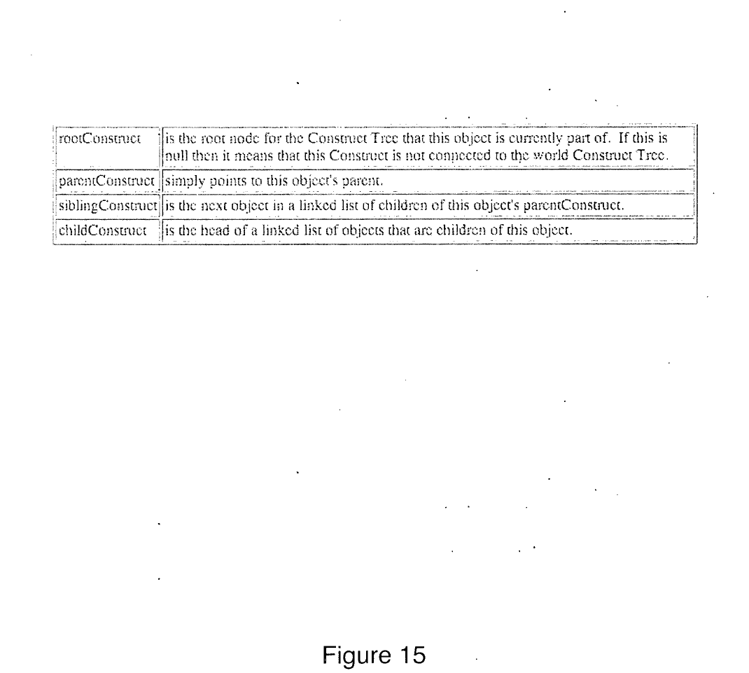

FIG. 15 lists exemplary construct tree organizational pointers, in accordance with an embodiment of the present invention. The basic building blocks of the present embodiment are objects that are instantiated from classes that all inherit from a common base class called Construct. This base class defines methods and data that allow the objects to be recognized by and interact with the server correctly. An object of the Construct class itself is not very interesting in terms of interface design and is never actually expected to be instantiated. People who wish to design interface objects should create their own classes that inherit from the Construct class. Messages such as, but not limited to, (void) Draw:(char)mode can be overridden to provide specific functionality that will be useful and interesting to those who wish to create user interfaces. The language programming conventions such as, but not limited to, calling [super init] before performing initializations in the init function and calling [super dealloc] in dealloc after cleanup should be adhered to if programmers choose to override those messages. Messages and data members can also be added to the new classes to customize the kind of functionality that the interface object designers desire.

Construct objects are preferably stored in an acyclic tree structure dictated by organizational pointers listed in FIG. 15. Because there is a clear hierarchy through the tree structure of what objects exert influence and organization on other objects, introducing a cycle would cause an infinite loop of object organization and the server would never be able to exit from evaluating object organization. Although the tree structure is the most suitable storage structure for this hierarchy of influence there might in the future come about more suitable structures. There are various messages in the Construct class that can alter the construct tree. For the objects in a construct tree to be serviced by the server the root of the tree must be added to a special Construct object called “world”. This object is of a special class, which functionality is defined, in the preferred embodiment, only internally by the server but may be referenced outside of the server through messaging. This class inherits from the Construct class, and thus would appear to be a normal object that can be interacted with in the system. However, the special class contains specific versions of organizational messages which cause objects that are added to it to show NULL as their parentConstruct and themselves as their rootConstruct. As far as the construct tree as a whole is concerned, not much has changed. The world object however is generally now aware of the tree's existence and thus the tree will be serviced (organization and drawing) by the system every frame. Programmers may keep a construct tree separate and unconnected from the world object and have other interactions with them but they will not be serviced by the server in the preferred embodiment.

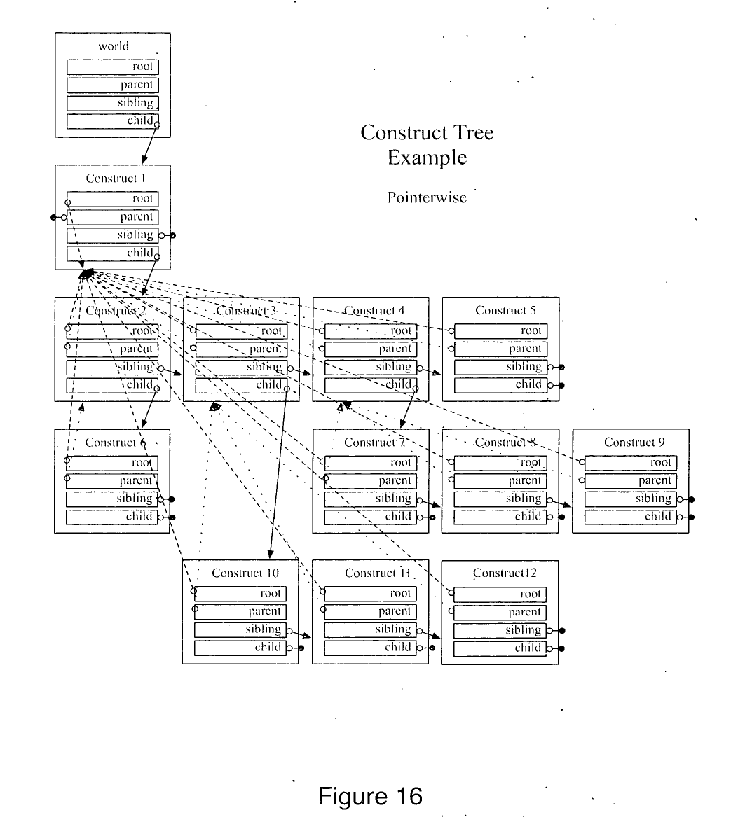

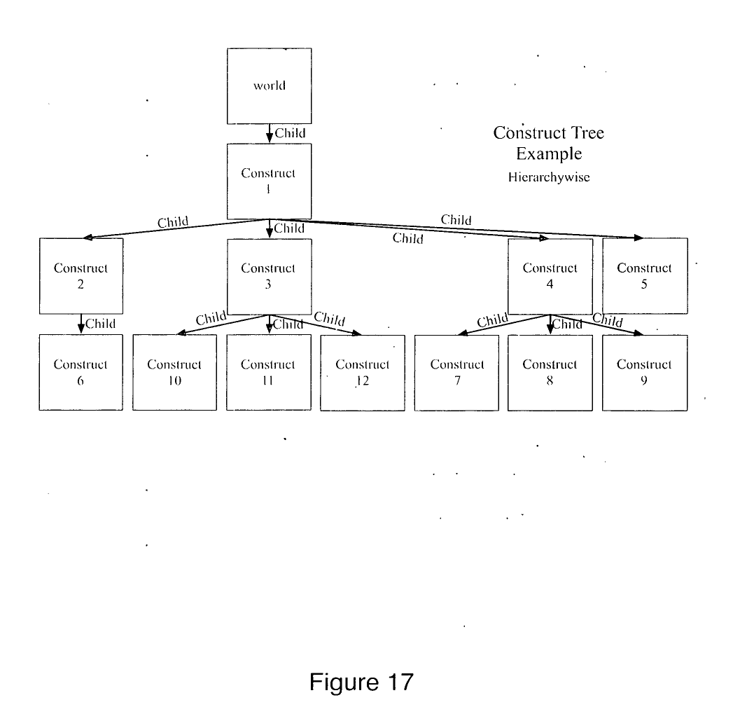

FIGS. 16 and 17 illustrate two different representations of the same construct tree, in accordance with an embodiment of the present invention. FIG. 16 visualizes it in terms of the actual organizational pointers, and FIG. 17 visualizes the object parent/child relationships.

In the present embodiment, when Construct objects are hooked into the world they preferably receive basic maintenance and service automatically at least every frame from the server. Other code may cause the server to service objects more than once per frame as needed but typically there is no need. In a typical application, the first thing that happens to the world's construct tree is that it is organized. Every object in the tree is passed a message in a depth first order, which tells the object to modify itself and its child objects so as to adapt them to the new situation if needed (Organization). This may be performed in a depth first order to help ensure that before an object potentially modifies any of its children's state that they have already been organized themselves. Other organization orders and methods might be used so long as the hierarchy of influence (organization) is maintained

The order with which sibling objects are sent the message is the order in which they reside in the siblingChild linked list headed by the childConstruct of the overlying, parentConstruct. This order is determined by the value of the organizationFlag member variable of the objects when they are added as a child object to their parent. This order can be altered after the fact or during addition of the child object through special messages defined in the Construct base class. The base definition of the organization message in the Construct class is to simply cause all of the Behavior objects currently attached to the Construct object to act on it. Thus, any class that overrides that message should be sure to call the organization message of the super class at some point. The reasoning behind this decision is to allow classes the ability to choose whether the attached Behavior objects (and consequently the organization methods of super classes) are enacted before or after the class' organization code. Whether a Construct object should implement organizational code as part of its organization method or instead be generalized out as a Behavior object is a very relevant design decision. In some applications it makes sense to tie the organizational code to the specific class but when reasonably possible organizational code should be abstracted out into a Behavior class, which can then be applied to other objects.

Continuing with the embodiment of the instant Figures, after all of the objects in the world's construct tree have been organized, they are drawn. The Core sends a draw message to every object in the construct tree in breadth first order to ensure that the overlying parent objects are drawn before their children. Sibling constructs are again drawn in the order that they reside in the sibling list, like in organization. Because the order of drawing is designated by the construct tree structure, drawing may occur contrary to z-ordering. There is generally no object based z-sorting occurring and so the specification of correct drawing order and blending is left to the programmer. Typically the hierarchical order of the construct tree will coincide with desired drawing orders and the drawing orders of specific child and sibling objects can be customized by altering their position in the linked lists that connect the construct tree. The server handles any necessary translations, rotations, scaling, and other things automatically before the draw message is sent. The power and convenience given by the server in the present embodiment is very great but there may be times where a programmer might want to forego it in favor of doing it themselves manually on encapsulated objects as described below. For example, without limitation, where a programmer might want to forego it as in examples described in a section below.

Organizing construct objects into construct trees is how most functionality in the application interface is implemented because it leverages a lot of powerful capability from server and its servicing routines. There are some applications, however, where it would be useful to service construct objects without them being subject to all of the services and organization of an object in a construct tree. One such example, without limitation, of this includes the idea of the indented hierarchy object. In a hierarchy object's organization method there is code that visually orders and organizes all of its child construct objects into a list. However, if it were an indented list there would be value in being able to treat one child object differently by indenting all child objects except for the one that is supposed to represent the overarching container or heading of the list. This can be performed on a single child object but it would require an extra member variable in the construct base class to distinguish it from the other children and it would require special cases to be coded into sorting and other routines that act on all the children. To help avoid those pitfalls the present embodiment uses a process that will be referred to as “encapsulation”. Instead of trying to make one of the children special it can be pulled out from the other child objects all-together and instead keep a specific reference to it in the hierarchy object, set its organizational pointers to special values and not even keep it in the construct tree proper at all. What this means is that it will be kept separate from all routines that act on the child objects and it saves adding memory to all construct objects. However, in the preferred embodiment, this also means that it will not get serviced by the system automatically like the other child objects which means that the hierarchy object is now responsible for organizing, drawing, releasing and any other needed maintenance pertinent to that encapsulated object. This allows for very tight control and optimization of the maintenance of objects that are encapsulated but with the tradeoff of more code on the part of the programmer. However, there is still not as much or as complex code as it would take to write special cases. Because the maintenance of encapsulated objects lies with their encapsulating, object unless specified otherwise with flags, they are for most purposes the same one object. Construct object pointers in construct subclasses do not necessarily denote that those objects are encapsulated and functionality-wise they are no different from pointers to encapsulated objects. The significant, if not only, difference is in how the class treats them.

Another good example of encapsulation that illustrates this concept is that of the PanelLabel object. There are the classes Panel and Label, which display a rectangular plane and text respectively. Because it is useful to have text set against a contrasting background, putting a Label object in front of or more preferably as a child of a Panel object is a common object arrangement. But it is tedious to build and describe that situation over and over in code and it would be better to create another class that would provide that combined functionality. The PanelLabel class is a suitable approach to overcome some, or all, of these issues.

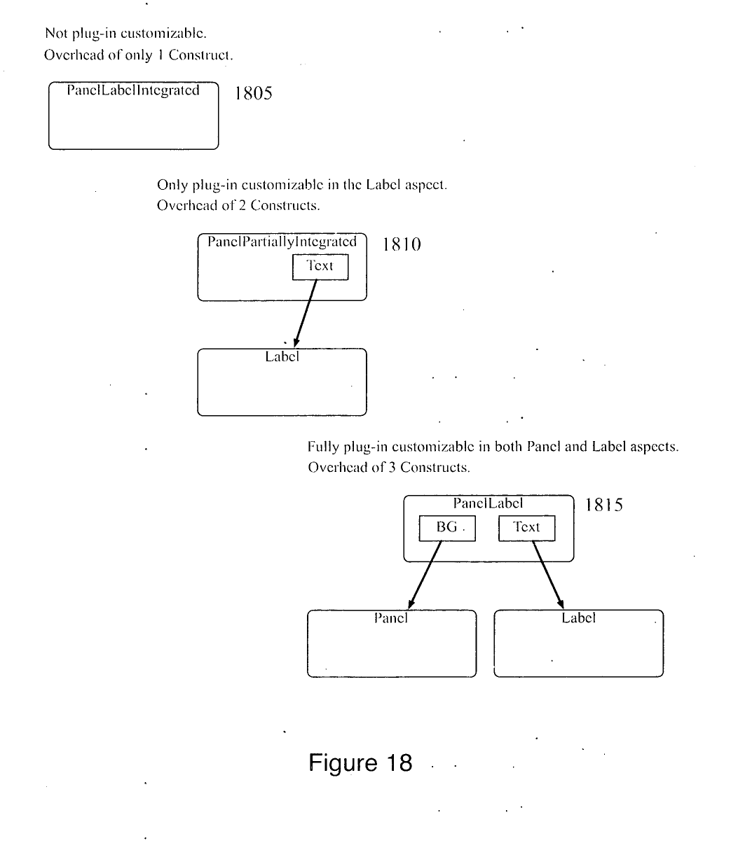

FIG. 18 illustrates three exemplary ways of organizing both of these pieces of functionality, hi accordance with an embodiment of the present invention. First is a class, noted as PanelLabelIntegrated 1805 in the diagram that simply inherits from the Construct base class and has the functionality of both the Panel and Label code copied into it. In one aspect, this mostly, if not only, produces the overhead of one object but has a disadvantage of not being independently upgradeable or customizable in many applications. For many applications, this means that as the Panel and Label classes are improved and given more functionality those improvements will usually not extend to the PanelLabelIntegrated 1805 object unless they are also copied in and adapted to it. In the preferred embodiment, it also generally does not allow for future subclasses of Panel or Label to be taken advantage of and so typically there can only be the hard-coded combination that the PanelLabelIntegrated 1805 class originally coded.

The next example brings some flexibility to the table at the cost of more overhead. This time the class marked PanelPartiallyIntegrated 1810 in the diagram, inherits from the Panel class, although it could just as well have been the Label class, and contains a Label object pointer, “Text” in the diagram, that is meant to point to an encapsulated Label object. In this example, the Label object can be switched out at runtime to take advantage of Label subclasses, which might be more suited to the program design. Also, any improvement that the Label class undergoes will automatically be leveraged without any recoding or linking of the PanelLabelPartiallyIntegrated 1810 class. However, the same flexibility does not generally extend to any future improvements/subclasses having to do with the Panel class because any addition or change in functionality to the Panel class is separate from the PanelPartiallyIntegrated class. If that same functionality were desired in the PanelPartiallyIntegrated class it would have to be recoded and recompiled separately.

The last example is how the PanelLabel 1815 class is typically implemented in the present embodiment. It takes the flexibility in the second example with the Label aspect and implements it with the Panel aspect as well. The PanelLabel 1815 class inherits directly from the Construct base class and now has two encapsulated object pointers. Now it can take advantage of any future advancement in both the Panel and the Label classes as well as any superclasses that are introduced. This flexibility comes at the cost of potentially three full object overheads. However, the PanelLabel 1815 may choose to only partially implement the maintenance overhead that it now manually controls in its two encapsulated objects, which can significantly reduce the total overhead. In some respects, this emulates the idea of multiple inheritance. When combining the functionality of more than one existing construct class, care must be taken in the design decisions of how exactly to implement the combination. In most case, however, the flexibility and power gained by the idea in the third PanelLabel 1815 example is well worth the overhead especially down the road when it can transparently take advantage of future advancements.

Generally, when construct trees become complex it is very cumbersome to try to maintain their construction purely by managing the source code that instantiates it. Thus, there arises a need for storage and retrieval of construct trees for reuse, clean coding policies and ease of creation/modification. There are facilities in the present embodiment's base classes and in the server that allow for easy archival and retrieval Construct Trees. There are also methods for more specific archival behavior available through subclass message overriding. When construct trees are loaded from files they can be used in a palette fashion where one construct tree is used as a prototype from with which to copy many other instances from or they can also simply be loaded and put to work in their intended fashion.

It is contemplated that there are a multiplicity of ways by which programmers can interact with present construct objects. For example, without limitation, the variable values can be changed by messages to them or in cases where direct object memory access is available, the programmer can alter their values directly. The present embodiment allows a programmer to also assign interacting objects such as, but not limited to, Timers, EventReceptors, Behaviors or other objects to them, which can alter data values and/or execute callback messages on objects. Programmers can typically assign those structures to their objects when they instantiate the interacting objects, and unless they are released beforehand they will automatically be released by the server if the objects they interact with are also released.

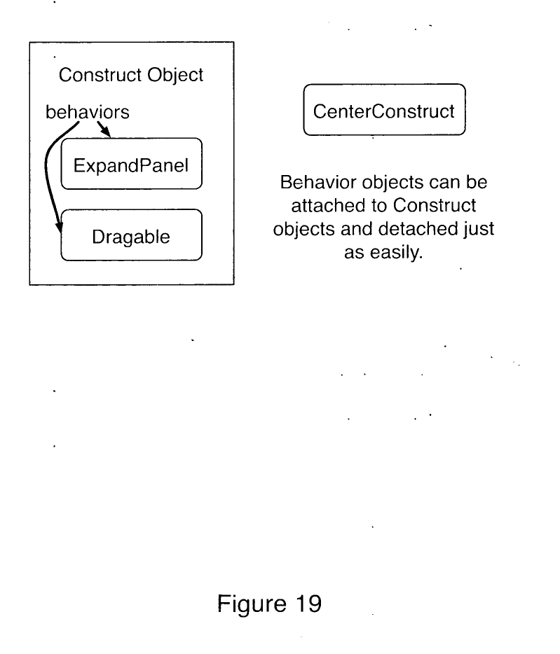

FIG. 19 is an exemplary behavior attachment diagram, in accordance with an embodiment of the present invention. In some embodiments, code that is used to modify and organize construct object data can be easily generalized and reused with objects of other classes. In this case, it would be beneficial to put it into a subclass of the Behavior base class. Another reason to pull it out into a Behavior class is if the organization and behavior uses a lot of memory and will only be used by a few instances of that Construct class. Instead that required memory can go into a Behavior object which can then be attached to a construct object to give it the desired behavior and then get rid of the Behavior object and in turn the associated memory when it is no longer needed or wanted. This makes sure that construct objects that do not take advantage of that behavior are not bogged down with the requisite memory. Like the Construct base class, a plain instance of the Behavior class in and of itself is not interesting and the Behavior class is meant to be sub-classed.

There are messages that can be usefully overridden in a Behavior class, one of which is the set message, which is called when a Behavior object is attached to a Construct object. Another is the act message which is called every time the Behavior objects are enacted on the object they are attached to which is typically during the organization maintenance phase of that Construct object if it is connected to the world's construct tree.

FIG. 20 illustrates how an exemplary Hinterface object interacts with Abstraction objects to process input, in accordance with an embodiment of the present invention. Hinterface objects represent actual human interface devices connected to the hardware and visible to the server. These are preferably managed by the server and should be mainly, if not only, of interest to Abstraction object writers. In the present embodiment when devices are connected, they are given Hinterface objects to interface with Abstraction objects. Abstraction objects decide whether to attach themselves to specific Hinterface objects of specific types. When the interface device produces input, the corresponding Hinterface object takes that input and passes it along to any abstractions that are attached to it in the form of a device part and value.

Human interface abstractions such as, but not limited to, the popular cursor are meant to give guidance and aid to the users of programs and dictate how they communicate back with the program. Abstraction objects can hold state and by default have basic selection functionality. Abstraction authors can choose to support any number or type of human interface devices from which to accept input. Some exemplary devices include, without limitation, mice, keyboards, head trackers, input clouds, motion gloves, tablets, gamepads, switches, buttons, video cameras, microphones, motion sensors or infrared sensors. This allows the benefits of new and innovative input devices to be transparently and instantly leveraged onto all programs that use Abstractions that have been updated to take advantage of the new devices. This also allows for a certain level of backwards compatibility in the event that the ideal device is not present.

As diagrammed in FIG. 20 when the user creates input with a device, its corresponding Hinterface delivers raw device events to all Abstraction objects that have assigned themselves to it. Those events are then translated into events in the context of the individual Abstraction object. Each abstraction then takes all of the EventReceptor objects that have been attached to it and performs evaluation processes to determine which EventReceptors have been triggered by the event if any. The corresponding callbacks assigned to the EventReceptors that fired are then called.

One example, without limitation, of this is a program built using the present embodiment that uses a cursor abstraction. The most ideal device to hook up to a cursor abstraction is currently a mouse, and so when the program requests the use of a cursor, the cursor abstraction sees that a mouse is attached and assigns itself to the mouse. However, if during the execution of the program the mouse is unplugged and taken away, the cursor abstraction sees that the mouse is no longer attached and starts looking for another device to assign itself to. First, it hopes to find another mouse, but if there are no other mice present to attach itself to it will then settle for the next best device as dictated by its own defined priorities. The abstraction may see that there is a keyboard attached to the system and assign itself to the keyboard. From that point the cursor could be moved by the user pressing the arrow keys and clicking could be handled through other key presses. Although a keyboard is generally not a very good way to control a cursor, it is better than not having anything at all. If a mouse was then brought back and plugged into the computer, the cursor abstraction would now be given the opportunity to upgrade itself from the keyboard to the mouse given that there is now a more suitable human interface device available for usage.

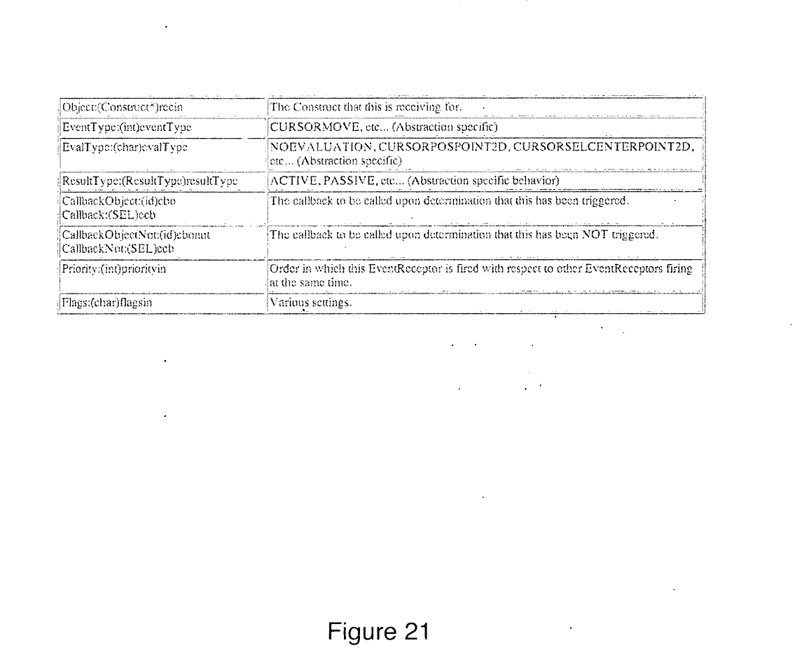

FIG. 21 outlines possible parameters passed for the creation of EventReceptors, according to an embodiment of the present invention. EventReceptors are objects that programmers create when they want something to happen as a result of user input or other spontaneous events. Whenever the input produced by connected devices produces events defined by Abstraction objects that the EventReceptor object is attached to and that the EventReceptor wishes to respond to, its corresponding callbacks are fired. To create them, a program sends a message to the EventReceptor class with all the pertinent information.

The Construct that is passed in for the “Object” parameter is the receiver of the evaluation test. It is also, along with the callback objects, attached to the EventReceptor during its life-span, meaning that if any of those Constructs are deallocated then the EventReceptors will be too. The EventType is the Abstraction specific event that will trigger a positive evaluation for this EventReceptor. The EvalType dictates what kind of evaluation route should be used such as, but not limited to, always passing, or passing only if the cursor is over at least one pixel of the rasterized object. The ResultType combined with the outcome of the evaluation test determine whether the callback for the EventReceptor will actually fire. CallbackObject is the object that receives the message defined in Callback if it is determined that the EventReceptor should fire its callback. CallbackObjectNot and CallbackNot are preferably fired only if it has been determined that the EventReceptor should not fire. Priority is an integer centered at zero that specifies an order of when this callback should fire in relation to other callbacks on the same Abstraction. This is useful, for example, without limitation, if there are callbacks that might destroy other EventReceptors that can fire on the same event, and it is desired that those callbacks are executed before they are destroyed. By default, all EventReceptors have a priority of zero and are evaluated from lowest to highest. Flags is a field for passing in O.R'ed parameters that dictate special state or function for an EventReceptor. An example of usage includes, without limitation, when it is desired that a callback fires if somebody clicks on a construct with a cursor. In the current embodiment the CallbackObjectNot, CallbackNot and priority parameters are optional. There might be other parameters useful for EventReceptor creation and usage.

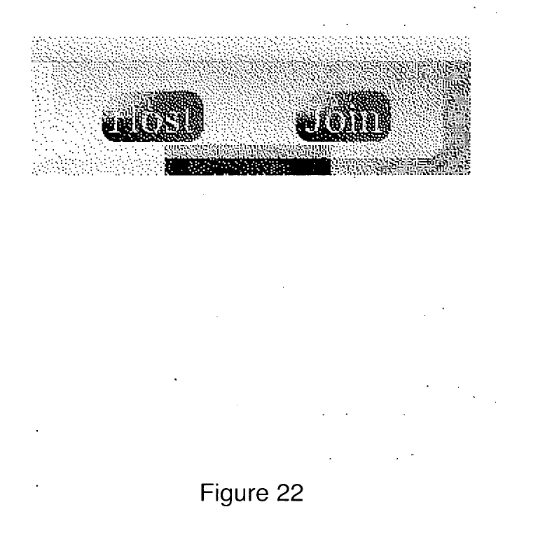

FIG. 22 illustrates two exemplary PanelLabel and one exemplary RoundedPanel Construct objects, in accordance with an embodiment of the present invention. Suppose that some message should be sent when the object denoted as “Host” is clicked. The code used to make that happen could look like, but not limited to, this (in Objective-C):
[VisionCursor EventReceptorOnAll: [EventReceptor Object: HostButton EventType: CURSOR 1 DOWN EvalType: CURSORPOSPOINT2D ResultType: ACTIVE CallbackObject: Connector Callback: @selector(Host) Flags: 0]];

What this code does in the present embodiment is create an EventReceptor object and then assigns it to all Abstraction objects of the type VisionCursor. The EventReceptor is setup so that a the callback message “Host” will be sent to the object “Connector” when any CURSOR 1 DOWN events are created on the Abstraction objects that are attached to it if the two dimensional cursor position (CURSORPOSPOINT2D) is over any pixel of the object HostButton at the time of the event and if it is the closest object in the z direction (a combination of ACTIVE and CURSORPOSPOINT2D) that receives CURSOR 1 DOWN events if evaluated in the same way (CURSORPOSPOINT2D) and also has a ResultType of ACTIVE.

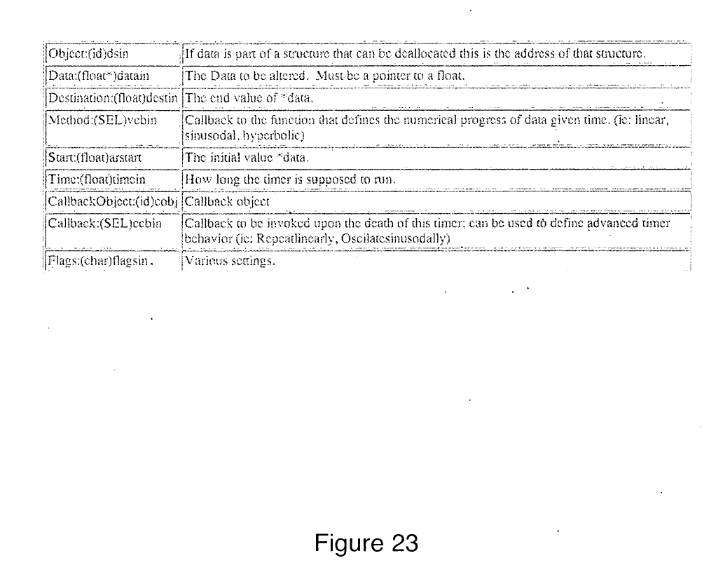

FIG. 23 outlines exemplary timer instantiation parameters, in accordance with an embodiment of the present invention. Timers are structures that, among other capabilities, act on data and execute callbacks based on time. They have high precision and retroactive capabilities. In the present embodiment, the server maintains them and they are associated with both the object that they are acting on and the callback object if they are present, meaning that if either of them are deallocated then the Timer is as well. Timer maintenance and evaluation happens once every server event loop.

In the present embodiment, “Object” is an object that is associated with this Timer for purposes of deallocation. If the Data: Destination: Method: parameters are present, then it is almost always the Object parameter that the data member that the Data: parameter is pointing to belongs to. Typically, Timer objects deallocate upon their completion but some types of Timers can keep going and avoid expiration. Data, Destination and Method parameters must all be present if any are. They represent a pointer to data that should be modified over the life-span of this Timer, what value it should be at the end of the Timer and what computation function should be used to get it there respectively. Start is a value that the Data is set to on the initial creation of the Timer. Timer is the amount of time in seconds that this Timer will exist or how long between events if it does not expire. CallbackObject and Callback are the parameters that dictate the object and routine to be executed when the Timer completes. Flags is a bit field in which various Timer settings are passed in in OR'ed form. In the current embodiment all parameters except the dataspace and flags parameters are optional.

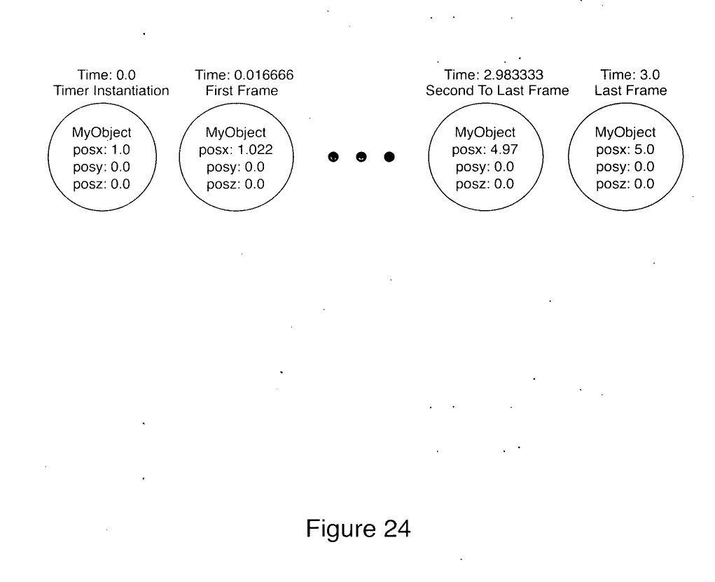

FIG. 24 illustrates an exemplary construct being affected by a Timer object, in accordance with an embodiment of the present invention. A simple usage example includes, without limitation, a situation in which it is desired to move an object from one place to another smoothly over a period of time. The code to perform that might look like, but not limited to, this (in Objective-C):
[Timer Object:MyObject Data:&posx Destination:5.0 Method: @selector(linear:) Time:3.0Flags:0];

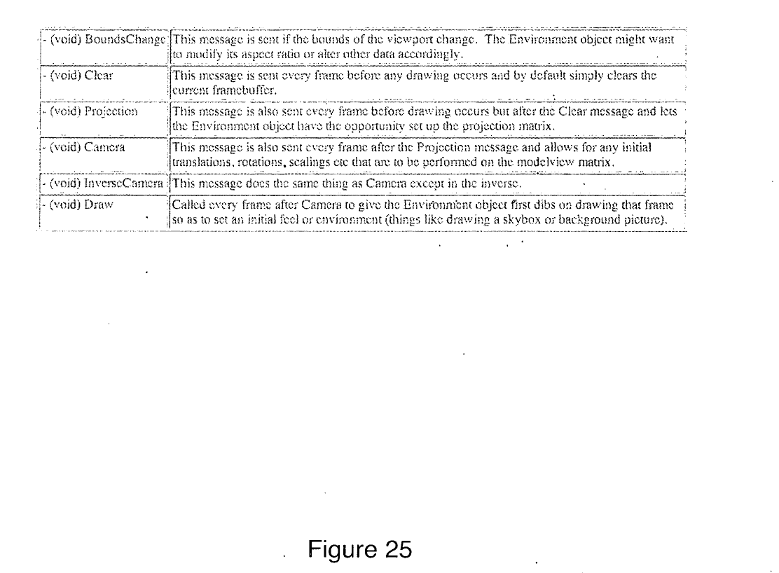

FIG. 25 lists exemplary major Environment methods, in accordance with an embodiment of the present invention. Environments are structures that define specific graphics API settings such as, but not limited to, the projection matrix and are also given a chance to draw in the framebuffer every frame before anything else for purposes of creating a specific feel to the environment. Like most of the public classes provided by the invention the Environment class is meant to be subclassed and have its messages overridden.

With this unique combination of different programming paradigms and a solid foundation of base objects, it is contemplated that application programmers using the embodiments of the present invention will be able to at least leverage its great power for flexibility and customization and create native 3D applications suitable for meeting the upcoming computing needs of the next generation.

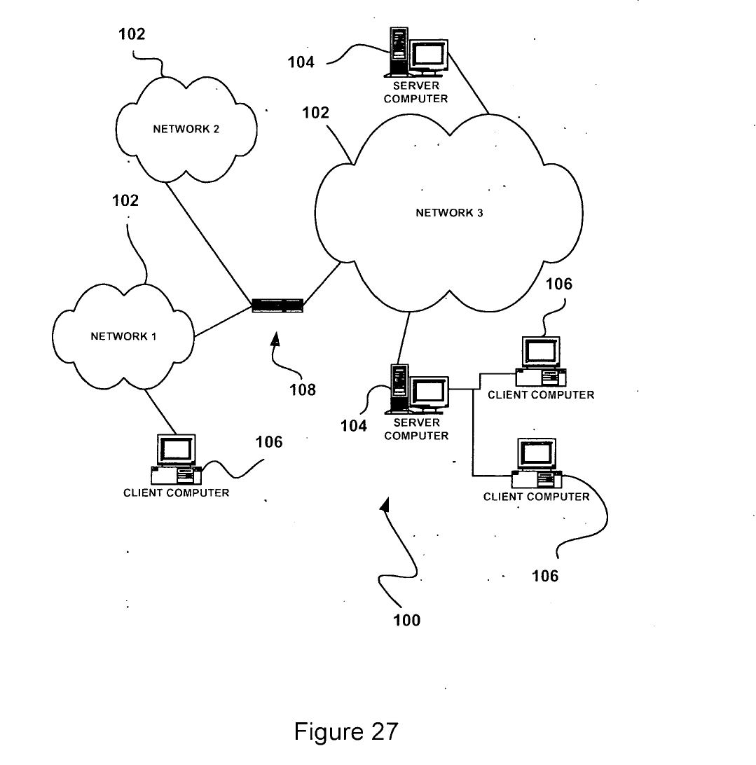

FIG. 27 illustrates a client-server network architecture 100 that, when appropriately configured or designed, can serve as a computer network in which the invention may be embodied. As shown, a plurality of networks 102 is provided. In the context of the present network architecture 100, the networks 102 may each take any form including, but not limited to a local area network (LAN), a wireless network, a wide area network (WAN) such as the Internet, etc.

Coupled to the networks 102 are server computers 104 which are capable of communicating over the networks 102. Also coupled to the networks 1.02 and the server computers 104 is a plurality of client computers 106. Such client computers 106 may each include a desktop computer, lap-top computer, mobile phone, hand-held computer, any component of a computer, and/or any other type of logic. In order to facilitate communication among the networks 102, at least one gateway or router 108 is optionally coupled therebetween.

It should be noted that any of the foregoing components in the present network architecture 100, as well as any other unillustrated hardware and/or software, may be equipped with various message management features. For example, the various server computers 104, client computers 106, and/or gateway/router 108 may be equipped with hardware and/or software for identifying a tone associated with incoming and/or out(going messages.

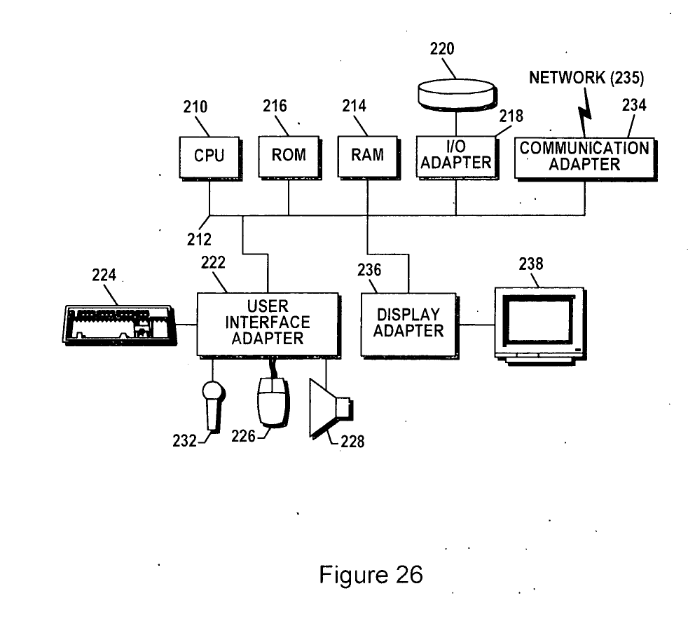

FIG. 26 shows a representative hardware environment that may be associated with the server computers 104 and/or client computers 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using, any of a wide variety of suitable processes and system modules, and is not limited to any particular computer hardware, software, middleware, firmware, microcode and the like.

Having fully described at least one embodiment of the present invention, other equivalent or alternative methods of implementing an extensible 3D interface programming framework according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the invention.

What is claimed is:

1. A system for an extensible 3D interface programming framework, the system comprising:
a server portion for loading and processing software code,
at least one server module comprising user interface software code and presentation software code, said at least one server modules providing at least one abstraction object, and
a client portion for processing application specific software code capable of requesting one or more server modules to be loaded in said server portion for processing and requesting said server portion to instantiate at least one object and data from said at least one server modules processing.

2. The system as recited in claim 1, in which said interface software code interacts with said presentation software code.

3. The system as recited in claim 1, in which said at least one server module are loaded dynamically.

4. The system as recited in claim 3, in which one or more of said server modules is configured to request one or more additional server modules to be loaded.

5. The system as recited in claim 1, in which said at least one abstraction object is attached to at least one object representing an actual human interface device.

6. The system as recited in claim 1, in which said client portion is configured to process multiple applications comprising said application specific software code.

7. The system as recited in claim 6, in which at least one multiple of said software applications is configured to make at least one request on at least one server module.

8. The system as recited in claim 7, in which said system is configured to process said software applications in at least one protective sandbox.

9. The system as recited in claim 1, further comprising a graphics processing unit (GPU) and said presentation software code comprises at least one graphics command that said GPU is configured to process.

10. The system as recited in claim 1, in which said objects are organized by classes.

11. The system as recited in claim 1, in which a Timer object is instantiated in said server portion.

12. The system as recited in claim 9, in which said system serves as a graphical user interface (GUI) of a consumer operating system.

13. A method of programming for an extensible 3D interface programming framework, the method comprising the steps of:
splitting a software application code into a server module portion and a client process portion;
creating at least one abstraction object associated with at least one device for said server module portion;
providing presentation software code operable for executing in said server module portion;
creating at least one object for receiving, an input event associated with said at least one abstraction object for said client process portion”
exchanging data between said server module portion and said client server portion using said at least one method of inter-process communication;
loading said server module portion into a server processing means; and
loading said client process portion into a client processing means.

14. The method as recited in claim 13, in which said software code for loading said server module portion is dynamic.

15. The method as recited in claim 13, further comprising the step of loading at least one external server modules into said server processing means.

16. The method as recited in claim 13, further comprising the step of organizing objects by classes.

17. The method as recited in claim 13, further comprising the step of executing said client process portion in a protective sandbox.

18. The method as recited in claim 13, in which said presentation software code comprises at least one graphics command for a GPU.

19. A method for an extensible 3D interface programming framework, the method comprising:
Steps for split process programming; and
Steps for programming a platform for 3D interfaces.

20. The system as recited in claim 19, further comprising means for implementing a protective sandbox.

21. A computer program product for an extensible 3D interface programming framework, the computer program product comprising:
computer code that is split into a server module portion and a client process portion;
computer code having at least one abstraction object associated with at least one device for said server module portion;
computer code for executing in said server module portion;
computer code that creates at least one object for receiving an input event associated with said at least one abstraction object for said client process portion;
computer programming code for exchanging data between said server module portion and said client server portion;
computer code for loading said server module portion into a server processing means; and
computer code for loading said client process portion into a client processing means.

22. The computer program product as recited in claim 21, in which said software code for loading said server module portion is dynamic.

23. The computer program product as recited in claim 21, further comprising computer code for loading at least one external server modules into said server processing means.

24. The computer program product as recited in claim 21, further comprising computer code that organizes objects by classes.

25. The computer program product as recited in claim 21, further comprising computer code for a protective sandbox that is operable for executing said client process portion therein.

26. The computer program product as recited in claim 21, in which said computer program product comprises at least one graphics command for a GPU.

27. A computer program product according to claim 21, wherein the computer-readable medium is one selected from the group consisting of a data signal embodied in a carrier wave, an optical disk, a hard disk, a floppy disk, a tape drive, a flash memory, and semiconductor memory.

28. A method of programming for an extensible 3D interface programming framework, the method comprising the steps of:
splitting a software application code into a server module portion and a client process portion;
providing presentation software code operable for executing in said server module portion;
exchanging data between said server module portion and said client server portion using said at least one method of inter-process communication;
loading said server module portion into a server processing means; and
loading said client process portion into a client processing means.
